(19) United States
(12) Patent Application Publication
(10) Pub. No.: US 2024/0044115 A1
(43) Pub. Date: Feb. 8, 2024

(54) RAINWATER COLLECTOR

(71) Applicant: ZERO ZERO ONE INTERNATIONAL, LLC, Wilmington, NC (US)

(72) Inventor: JIAO LI, Fengcheng (CN)

(73) Assignee: ZERO ZERO ONE INTERNATIONAL, LLC, Wilmington, NC (US)

(21) Appl. No.: 17/941,153

(22) Filed: Sep. 9, 2022

(30) Foreign Application Priority Data
Aug. 5, 2022 (CN) 202222062763.1

(51) Int. Cl. E03B 3/02; B01D 35/02

(52) U.S. Cl. CPC E03B 3/02; B01D 35/02; B01D 2221/12

(57) ABSTRACT

A rainwater collector, comprising a housing configured to penetrate from top to bottom, an opening at upper end of the housing is a water inlet, an opening at lower end of the housing is a water outlet, water collecting ports are arranged on both sides of the housing, the height of the water collecting port is lower than upper end face of the water-passing pipe, the water collecting port is configured to connect the valve. Inside the housing are arranged: a filter and a diverter, the filter comprises a water-passing pipe, grid plates are evenly arranged on outer side of upper end of the water-passing pipe, the grid plates are used to filter rainwater; the diverter is arranged above the filter. In the present application, a diverter and a filter are arranged in the housing to intercept and filter the rainwater, and the debris are filtered and collected.

### CROSS-REFERENCE TO RELATED APPLICATIONS

This application claims the benefit and priority of Chinese patent application No. 202222062763.1, filed on Aug. 5, 2022, disclosure of which is hereby incorporated by reference in its entirety.

### TECHNICAL FIELD

The present application relates to the technical field of rainwater collection, and more particularly, to a rainwater collector.

### BACKGROUND

With the development of social economy and the continuous increase of population, the shortage of water resources has become a very serious environmental problem faced by human society at present, and even a problem of human survival in the future. Water is the source of life and the basic condition for human survival. Only 3% of the freshwater resources on the earth are available for human use. For thousands of years, human beings have been making unremitting efforts to maximize the use of freshwater, and gradually realized that water resources are not inexhaustible, and the efficient use of freshwater resources has become a new trend. Nowadays, the utilization of water resources is often improved by using rainwater. After the rainwater is collected, it can be simply treated to achieve the standard of water reuse. It can be used to water flowers and wash cars. Compared with the use of tap water, it has a high utilization value. The use of rainwater can save the use of tap water while saving the consumption of tap water, and the overall cost savings is considerable. The value of rainwater reuse and treatment reasonably and efficiently to society has been more and more accepted by contemporary people.

The existing rainwater collectors are installed in the open air, and the rainwater is often mixed with large debris such as branches and leaves, which are easy to cause blockage in the pipeline, and the corrosion of the branches and leaves will also affect the water quality, which is not conducive to the recycling of rainwater.

In addition, most of the existing rainwater collectors cannot adapt to various pipe sizes, and the efficiency of collecting rainwater is low. In the weather of strong wind, it will collide with the wall and generate noise.

The above shortcomings need to be improved.

### SUMMARY

In order to overcome the fact that the existing rainwater collector does not filter the impurities in the rainwater, which is likely to cause pipe blockage and contamination of the collected rainwater, the present application provides a rainwater collector.

The technical solution of the present application is as follows:

A rainwater collector, comprising a housing, which is configured to penetrate from top to bottom, wherein an opening at upper end of the housing is a water inlet, an opening at lower end of the housing is a water outlet, wherein inside the housing are arranged: a filter for filtering rainwater; a diverter arranged above the filter. After the rainwater enters from the water inlet, the diverter diverts the rainwater, so that the rainwater flows through the filter, so as to filter the rainwater, reduce the impurities in the rainwater, and facilitates the utilization.

Furthermore, the housing is in the shape of a waist drum with a smaller diameter at both ends and a bigger diameter at middle, wherein the housing comprises a top cover, an upper cover and a base, and the top cover, the upper cover and the base are snapped together in sequence, a snap joint between the upper cover and the base is located at the largest diameter of the housing. Each part of the housing is connected by snap connection, which is easy to install and disassemble, and the parting surface is set at the largest diameter. When installing the internal components of the housing, the opening between the upper cover and the base is large, this facilitates the installation of components in the upper cover or the base.

Furthermore, connecting ribs are provided on outer side of lower end of the top cover and inner side of top end of the base, and grooves are provided on outer side of top end of the filter, and the groove on the filter and the connecting rib on the base are engaged with each other.

Furthermore, one side of the housing is a plane, and an edge of the plane is provided with a nailing lug, which is convenient for fixing the rainwater collector

Furthermore, the filter comprises a water-passing pipe, and grid plates are evenly arranged on outer side of upper end of the water-passing pipe.

Furthermore, the grid plates are arranged vertically, and one end of the grid plates close to inner wall of the housing is higher than the other end, so that the impurities filtered on the grid plate can slide down into the water passage and then be discharged from the water outlet.

Furthermore, water collecting ports are arranged on both sides of the housing and the height of the water collecting port is lower than upper end face of the water-passing pipe, and the water collecting port is configured to connect valve, which is convenient to connect the valve from different directions of the rainwater collector according to the needs, which is convenient for use.

Furthermore, a connecting seat is provided at bottom of the housing, which is convenient for connecting the drain pipe.

Furthermore, a baffle plate is provided in the connecting seat, which is convenient to apply to the diameter of the drain pipes of different sizes.

Furthermore, support columns are inserted into the bottom of the diverter, bottom of the support column is inserted into the filter, and the four sides of the diverter are inclined surfaces, so that the rainwater naturally slides onto the grid plate on the diverter, so as to avoid the accumulation of rainwater and impurities on the diverter.

Furthermore, a projected area of the diverter on horizontal plane is larger than the flow area of the water inlet and the water-passing pipe, so that the diverter fully plays the role of diverting the rainwater.

The beneficial effects of the present application based on the above-mentioned technical solutions are:
1. The rainwater collector described in the present application can collect rainwater more efficiently and filter some impurities effectively by arranging a diverter and a filter in the housing.
2. In the rainwater collector described in the present application, by configuring one side of the housing to be flat, it can be closely attached to the wall, and a connecting seat is arranged at the bottom of the housing, and a separating plate is arranged in the connecting seat, which can better match various types of rainwater pipe. The rainwater collector is prevented from wobbling and falling by securing the housing to the wall by penetrating nails through the nailing lugs.
3. In the rainwater collector described in the present application, by arranging water collecting ports on both sides of the housing, it can better communicate with rainwater collecting buckets in multiple directions, and the pipes are not easy to wrinkle, which is convenient for collecting rainwater.

### BRIEF DESCRIPTION OF DRAWINGS

In order to illustrate the technical solutions in the embodiments of the present application more clearly, the following briefly introduces the accompanying drawings that need to be used in the description of the embodiments or the prior art. Obviously, the drawings in the following description are only some embodiments of the present application, and for those of ordinary skill in the art, other drawings can also be obtained from these drawings without creative effort.

FIG. 1 is an exploded structural diagram of the application,

FIG. 2 is a schematic perspective structural diagram the application;

FIG. 3 is a schematic diagram of the internal structure of the application;

FIG. 4 is a schematic structural diagram of the bottom of the base of the application.

### REFERENCE SIGNS

1. Housing; 11. Water inlet; 12. Water outlet; 13. Top cover; 131. Connecting ribs; 14. Upper cover; 15. Base; 16. Nailing lug; 17. Water collecting port; 18. Connecting seat; 19. Baffle plate; 2. Filter; 21. Water-passing pipe; 22. Grid plate; 23. Groove; 3. Diverter; 31. Support column.

### DETAILED DESCRIPTION

In order to make the technical problems, technical solutions and beneficial effects to be solved by the present application more clear, the present application will be further described in detail below with reference to the accompanying drawings and embodiments. It should be understood that the specific embodiments described herein are only used to explain the present application, but not to limit the present application.

It should be noted that when a component is referred to as being “fixed” or “disposed” or “connected” to another component, it can be directly or indirectly located on the other component. The terms “center”, “upper”, “lower”. “left”, “right”, “vertical”, “horizontal”, “inner”, “outer”, etc. which are used to indicate position or positional relationship are based on the position or positional relationship shown in the drawings, and are only for the convenience of describing the application and simplifying the description, therefore cannot be understood as a limitation of the present application. The terms “first”, “second”, etc. are only used for the purpose of description, and should not be construed as indicating or implying relative importance or implying indicating the number of technical features. “A plurality of” means two or more, unless expressly and specifically limited otherwise. “Several” means one or more than one, unless expressly specifically defined otherwise.

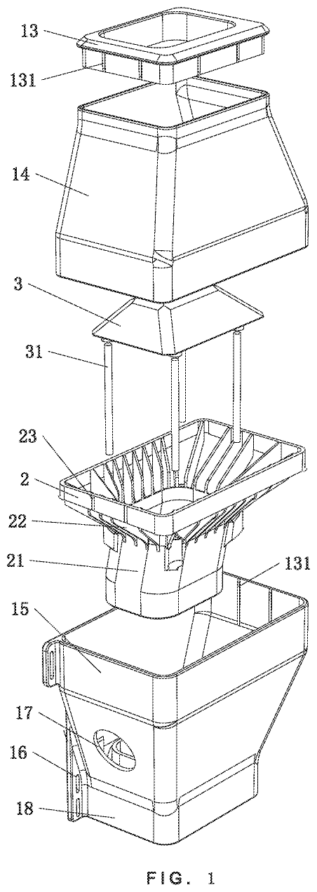

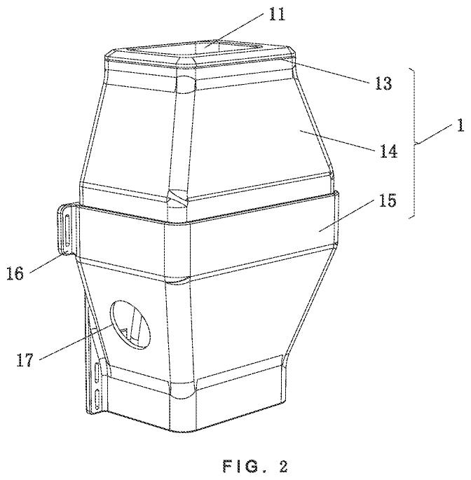

As shown in FIG. 1 to FIG. 4, a rainwater collector described in the present application comprises a housing 1, which is configured to penetrate from top to bottom, wherein an opening at upper end of the housing 1 is a water inlet 11, an opening at lower end of the housing 1 is a water outlet 12. Water collecting ports 17 are arranged on both sides of the housing 1 and the height of the water collecting port 17 is lower than upper end face of the water-passing pipe 21, and the water collecting port 17 is configured to connect valve. Inside the housing 1 are arranged a filter 2 and a diverter 3. The filter 2 comprises a water-passing pipe 21, and grid plates 22 are evenly arranged on outer side of upper end of the water-passing pipe 21. The grid plates 22 are used for filtering rainwater. The diverter 3 is arranged above the filter 2.

Before the application is used, the rainwater collector is communicated with various components in the rainwater collection system, wherein the water inlet 11 is communicated with the rainwater collecting pipeline, the water outlet 12 is communicated with the drain pipe, and the water collecting port 17 is installed with a valve, and the other end of the valve is connected with the rainwater collecting bucket through a pipeline; When in use, the rainwater collecting pipe will collect rainwater and enter it into the rainwater collector, and the collected rainwater will enter the housing 1 from the water inlet 11. Since the diverter 3 is arranged above the filter 2, the rainwater flows to the grid plate 22 of the filter 2 after being diverted in the housing 1 through the diverter 3. Rainwater enters the space between the water pipe 21 and the housing 1 through the grid plate 22. Open the valve to collect rainwater into the rainwater collecting bucket. A valve can be installed on the water collecting port 17 on one side, a plug can be installed on the water collecting port 17 on the other side, or valves can be installed on both sides as required. When the rainfall is large or the rainwater in the rainwater collecting bucket is full, the rainwater accumulated in the housing 1 exceeds the upper end surface of the water pipe 21, so that the rainwater overflows through the water pipe 21 and flows into the drain pipe for discharge. The rainwater flowing from the drain pipe can be collected and used for occasions with lower water quality requirements, which improves the efficiency of rainwater utilization. Large debris such as branches and leaves in the rainwater are trapped on the grid plate 22, and the accumulation on the grid plate 22 will reduce the penetration gap and improve the filtering effect of the grid plate 22. When the accumulation is too much, the rainwater cannot pass through the grid plate 22. At this time, it is directly discharged from the drain pipe, and the debris on the grid plate 22 need to be cleaned regularly during use to ensure the filtering effect of the grid plate 22.

In a preferred example, as shown in FIGS. 1 to 3, the housing 1 is in the shape of a waist drum. The diameter of the water inlet 11 and the water outlet 12 at both ends is small, and the diameter in the middle is large. The housing 1 is composed of a top cover 13, an upper cover 14 and a base 15. The top cover 13, the upper cover 14 and the base 15 are snapped together in sequence, and the snap joint of the upper cover 14 and the base 15 is located at the largest diameter of the housing 1. Each part of the shell 1 is connected by snap connection, which is easy to install and disassemble, and the parting surface is set at the largest diameter. When installing the internal components of the housing 1, the opening between the upper cover 14 and the base 15 is large, this is convenient for putting the components into the upper cover 14 or the base 15 for installation. Support columns 31 are inserted into the bottom of the diverter 3, bottom of the support column 31 is inserted into the filter 2, and the bottom of the filter 2 is plugged with the base 15, and the plug connection is convenient for disassembly and installation, which facilitates the installation of the diverter 3 and the filter 2 into the housing 1, and facilitates subsequent maintenance and cleaning.

In a preferred example, as shown in FIG. 1, connecting ribs 131 are provided on the outside of the lower end of the top cover 13 and on the inside of the top end of the base 15. By arranging the connecting ribs 131, the outer dimension of the top cover 13 is increased, so that the connection between the top cover 13 and the upper cover 14 is more tightly, and the inner size of the base 15 is reduced, so that the connection between the base 15 and the upper cover 14 is more tightly, and the connecting ribs 131 increase the structural strength of the top cover 13 and the base 15. In addition, the outer side of the top of the filter 2 is provided with grooves 23, and the groove 23 on the filter 2 and the connecting rib 131 on the base 15 are engaged with each other, so that the base 15 further restricts the position of the filter 2, which makes the two more closely connected.

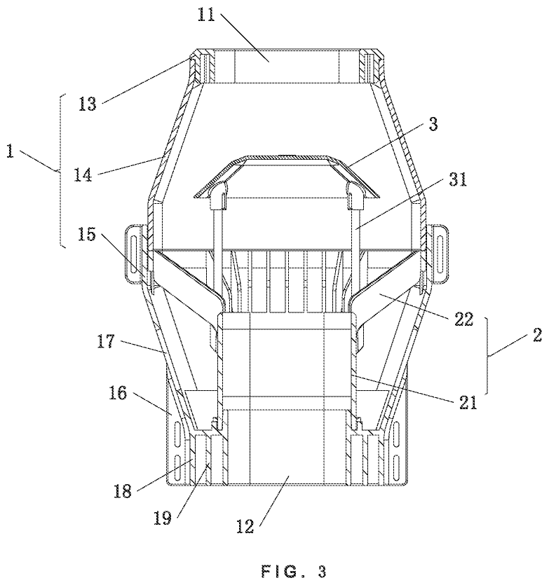

In a preferred example, as shown in FIG. 3, the grid plate 22 is arranged vertically. On the one hand, the vertically arranged grid plate 22 makes the grid plate 22 have a sufficiently large size, so that it has sufficient strength and is not easily damaged, and one end of the grid plate 22 is in contact with the inner wall of the housing 1, and the other end is connected with the water passage 21 to support the housing 1, thereby improving the structural strength of the housing 1, so that the housing 1 is not easily damaged by crushing. On the other hand, the vertically arranged grid plates 22 occupy a small space on the horizontal plane, so as to ensure that there is enough water passing space between the grid plates 22 to ensure the water passing efficiency, and one end of the grid plate 22 close to the inner wall of the housing 1 is higher than the other end, so that the upper end surface of the grid plate 22 is inclined. The debris trapped on the grid plate 22 falls into the water pipe 21 along the inclined plane and is discharged from the drain pipe. It is not easy to accumulate debris on the grid plate 22, which reduces the cleaning frequency of personnel and reduces the labor intensity of personnel.

In a preferred example, as shown in FIGS. 1 to 3, one side of the housing 1 is a plane, and an edge of the plane is provided with a nailing lug 16. The plane is easy to fit with the wall. Use screws or nails to pass through the through holes on the nailing lug 16 to fix the housing 1 to the wall to prevent the rainwater collector from shaking or falling, so that the rainwater collector can work stably.

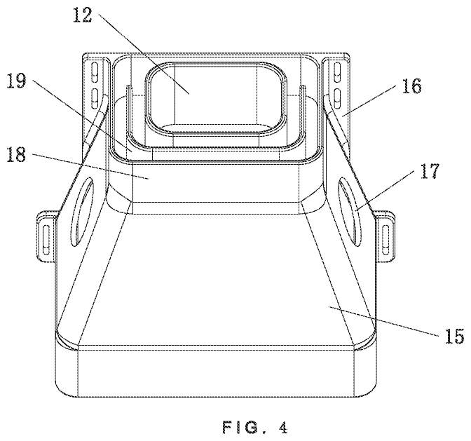

In a preferred example, as shown in FIG. 4, the bottom of the housing 1 is provided with a connecting seat 18, and a baffle plate 19 is provided in the connecting seat 18, which is convenient for connecting the drain pipe, so that it can be applied to the two specifications of the general square rainwater pipe in the United States. They are 2-inch*3-inch rainwater pipes and 3-inch*4-inch rainwater pipes, which can be designed according to the needs of users in the actual production process, including but not limited to the above two sizes.

In a preferred example, as shown in FIG. 1 and FIG. 3, the four sides of the diverter 3 are inclined surfaces, which are easy to guide the water flow and are not easy to accumulate dirt and impurities. The projected area of the diverter 3 on the horizontal plane is larger than the flow area of the water inlet 11 and the water-passing pipe 21, so that the diverter 3 has a sufficiently large diverting area. The rainwater entering the housing 1 is led to the grid plate 22, so that the rainwater in the housing 1 can be filtered by the grid plate 22 to reduce debris in the rainwater and improve the water quality of the rainwater, and facilitate subsequent use.

The above are only the preferred embodiments of the present application, and are not intended to limit the present application. Therefore, any modification, equivalent replacement, improvement, etc. made to the above embodiments according to the technical practice of the present application still fall within the scope of the technical solution of the present application.

What is claimed is:

1. A rainwater collector, comprising:
a housing configured to penetrate from top to bottom, wherein an opening at upper end of the housing is a water inlet, an opening at lower end of the housing is a water outlet,
wherein inside the housing are arranged:
a filter for filtering rainwater;
a diverter arranged above the filter, and the diverter is configured to guide rainwater.

2. The rainwater collector according to claim 1, wherein the housing is in the shape of a waist drum with a smaller diameter at both ends and a bigger diameter at middle, wherein the housing comprises a top cover, an upper cover and a base, and the top cover, the upper cover and the base are snapped together in sequence, a snap joint between the upper cover and the base is located at the largest diameter of the housing.

3. The rainwater collector according to claim 1, wherein one side of the housing is a plane, and an edge of the plane is provided with a nailing lug.

4. The rainwater collector according to claim 1, wherein the filter comprises a water-passing pipe, and grid plates are evenly arranged on outer side of upper end of the water-passing pipe.

5. The rainwater collector according to claim 4, wherein the grid plates are arranged vertically, and one end of the grid plates close to inner wall of the housing is higher than the other end.

6. The rainwater collector according to claim 4, wherein water collecting ports are arranged on both sides of the housing and the height of the water collecting port is lower than upper end face of the water-passing pipe, and the water collecting port is configured to connect valve.

7. The rainwater collector according to claim 1, wherein a connecting seat is provided at bottom of the housing, and a baffle plate is provided in the connecting seat.

8. The rainwater collector according to claim 2, wherein connecting ribs are provided on outer side of lower end of the top cover and inner side of top end of the base, and grooves are provided on outer side of top end of the filter, and the groove on the filter and the connecting rib on the base are engaged with each other.

9. The rainwater collector according to claim 1, wherein support columns are inserted into the bottom of the diverter, bottom of the support column is inserted into the filter, and the four sides of the diverter are inclined surfaces.

10. The rainwater collector according to claim 4, wherein a projected area of the diverter on horizontal plane is larger than the flow area of the water inlet and the water-passing pipe.
